(19) United States
(12) Patent Application Publication
(10) Pub. No.: US 2010/0119241 A1
(43) Pub. Date: May 13, 2010

(54) ADAPTIVE FREQUENCY DOMAIN EQUALIZATION WITHOUT CYCLIC PREFIXES

(75) Inventors: KAI YANG, Murray Hill, NJ (US); Ting Wang, West Windsor, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/567,398

(22) Filed: Sep. 25, 2009

Related U.S. Application Data
(60) Provisional application No. 61/112,938, filed on Nov. 10, 2008.

(51) Int. Cl. H04B 10/06

(52) U.S. Cl. 398/208

(57) ABSTRACT

Polarization multiplexing, optical communications systems can suffer from chromatic dispersion and polarization mode dispersion, resulting in channel delay spread. These errors can be compensated quickly and simply in the frequency domain. By obviating the need for a cyclic prefix, the complexity of the equalization can be reduced by more than a factor of twenty.

### RELATED APPLICATION INFORMATION

This application claims priority to provisional application Ser. No. 61/112,938 filed on Nov. 10, 2008, incorporated herein by reference.

### BACKGROUND

1. Technical Field

The present invention relates to optical communications systems, and more particularly to an apparatus and a method for compensating for chromatic dispersion and polarization-mode dispersion in a coherent, polarization multiplexing receiver.

2. Description of the Related Art

Most installed Ethernet backbones, based on multi-mode fibers, operate at bit rate of roughly 1 Gb/s, which is inadequate for current and emerging demands. Recently, polarization multiplexing (PolMux) systems with coherent detection schemes have received significant research interests for high-speed (40 Gb/s and beyond) transmissions. Unlike the conventional systems, PolMux system with coherence detection could utilize advanced signal processing technologies to mitigate optical-channel distortions, including chromatic dispersion (CD), polarization-mode dispersion (PMD), polarization de-multiplexing (PolDeMux), frequency offset, and phase noise.

CD and PMD are two most dominant optical-channel distortion effects. CD is usually a much larger impairment than PMD, and can be a significant distortion even at relatively low data rates on long fibers.

CD is an effect based either in the refractivity of a medium, or in the geometric properties of the medium, which cause different frequencies of electromagnetic radiation to travel through the medium at different rates. The result is that a pulse of light spreads out as it travels over great distances. Optical lasers output pulses of light with a finite spectrum comprising colors. The longer the fiber over which a pulse travels, the wider the pulse spreads out. Difficulties arise when the resulting energy from a pulse begins to interfere with that of an adjacent pulse. This interference causes inter-symbol interference in the electrical domain.

CD effects are determined by each optical fiber, and can typically be considered stable over time. Because of its stability, CD can be compensated for using a passive device (e.g., medium having dispersion effects which counteract the dispersion of the transmission medium). However, such passive devices have drawbacks, in that they substantially reduce the optical signal-to-noise ratio.

PMD, meanwhile, is an effect based in the defects of the transmission medium and cannot be compensated for passively. In an ideal medium, signals traveling in orthogonal polarizations will travel at the same speed. In real media, however, defects cause random differences in the speeds of the respective polarizations, causing the polarizations to drift with respect to one another. PMD, in contrast to CD, is not a significant problem for most fibers until data rates exceed 10 Gb/s. However, in contrast to CD, PMD on long fibers changes randomly over time. The dynamic characteristic of PMD makes it a difficult problem for high-speed optical transmissions.

In a PolMux system with coherence detection, adaptive signal processing methods can be carried out in the time domain to compensate for PMD and CD. However, the complexity of the time-domain signal processing methods increase quickly with the channel delay spread. Consequently, time-domain methods are difficult to implement for high-speed long-distance fiber systems, where the dispersion may span several hundreds of symbol durations.

Optical and electronic compensation methods exist for PMD and CD. The two types of dispersion are typically compensated for using two separate devices. Optical PMD compensation can compensate for first and second order PMD. However, because polarization dispersion can change rapidly with time, the speed of optical PMD compensation is often not enough to compensate for the fastest polarization changes that can occur.

Optical CD compensation is often attained by inserting appropriately chosen dispersion compensating fiber (DCF) into the optical path. DCF exhibits an opposite dispersive effect of the standard single mode fiber. However, adding a DCF gives rise to a reduction of the receiving optical signal-to-noise ratio (SNR) and thereby degrades the performance of the system.

Compensation for CD and PMD can also be accomplished electronically by using digital signal processing methods, and channel equalization methods in particular. The channel equalization method can be broadly grouped into two categories (i.e., time-domain methods and frequency-domain methods).

There exists a large body of work on time-domain equalization methods, ranging from the simple linear equalization method to the sophisticated maximum-likelihood (ML) detector. An ML detector can achieve the optimal bit-to-error rate (BER) performance at the expense of high computational complexity. On the other hand, the linear equalization method based on a time-domain finite impulse response (FIR) filter is simple to implement and can effectively suppress the distortions. The complexity of the linear equalization method is proportional to O(M²), where M is the number of taps in the FIR filter and typically increases proportionally with that of the channel delay spread. However, as noted above, the channel delay spread for high-speed, long-distance fiber systems may span several hundred symbol durations. Because the complexity increases with the square of the number of taps, even the conceptually simple linear equalization method can be very difficult to implement in real-time, due to its high computational complexity.

An alternative approach is to perform equalization in the frequency domain. However, in the prior art techniques, a cyclic prefix must to be appended to the end of each data frame, which brings about extra overhead and also increases the complexity of implementation. Compensation for CD that relies on foreknowledge of the dispersive effects of the particular channel it is being used with cannot account for the dynamic errors introduced by PMD.

### SUMMARY

A polarization-multiplexing, optical receiver is shown. The receiver has an adaptive frequency domain equalizer to compensate for chromatic dispersion (CD) and polarization multiplexing dispersion (PMD). A fast Fourier transform module converts a time-domain input signal to a frequency-domain signal. A dual-dispersion estimation module calculates coefficients from the time-domain input signal. A multiplier multiplies the coefficients and the frequency-domain signal to produce a compensated frequency-domain signal. An inverse FFT module converts the frequency-domain signal to a time-domain output signal.

A method for adaptive frequency domain equalization is also shown. The method includes compensating for chromatic dispersion and polarization-mode dispersion in a complex polarization signal in the frequency domain. The step of compensating further includes determining coefficients from the complex polarization signal, converting the complex polarization signal to a frequency-domain signal, multiplying the coefficients and the frequency-domain signal to produce a compensated frequency-domain signal, and converting the compensated frequency-domain signal to a time-domain output signal.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a polarization multiplexing, optical communications system which uses adaptive frequency domain equalization (FDE).

FIG. 2 is a block diagram showing in detail a technique for adaptive FDE which does not use a cyclic prefix.

### DETAILED DESCRIPTION OF PREFERRED EMBODIMENTS

According to the present principles, it is possible to simultaneously compensate for chromatic dispersion (CD) and polarization mode dispersion (PMD) in the frequency domain without the use of a cyclic prefix.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device). The medium may include a computer-readable medium such as a semiconductor or solid state memory, magnetic tape, a removable computer diskette, a random access memory (RAM), a read-only memory (ROM), a rigid magnetic disk and an optical disk, etc.

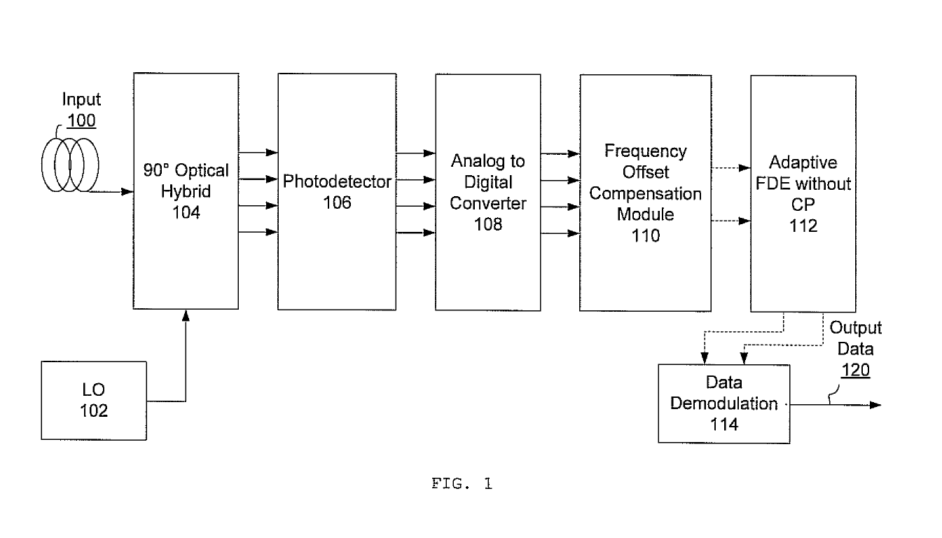

Referring now to the drawings in which like numerals represent the same or similar elements and initially to FIG. 1, a system which performs adaptive frequency domain equalization is shown. The 90° Optical Hybrid 104 receives as input a polarization multiplexed optical signal 100 and a reference signal from Local Oscillator 102. The Optical Hybrid 104 produces four optical signals, which are received by photodetectors 106. The photodetectors convert the optical signals into electronic signals and sends those signals to Analog to Digital Converter (ADC) 108. The ADC in turn passes the digital signals to Frequency Offset Compensation Module (FOCM) 110. The FOCM processes the four digital signals, reducing them into two complex signals (denoted by dashed lines). The FOCM finds offsets between the frequencies of the received signal and a local reference signal.

The adaptive frequency domain equalizer (FDE) 112 converts the time-domain complex signals to the frequency-domain. The adaptive FDE 112 then compensates for chromatic dispersion (CD) and polarization mode dispersion (PMD) without the use of a cyclic prefix. The adaptive FDE 112 outputs the compensated signals, which are then processed by data demodulator 114 and output from the system as data.

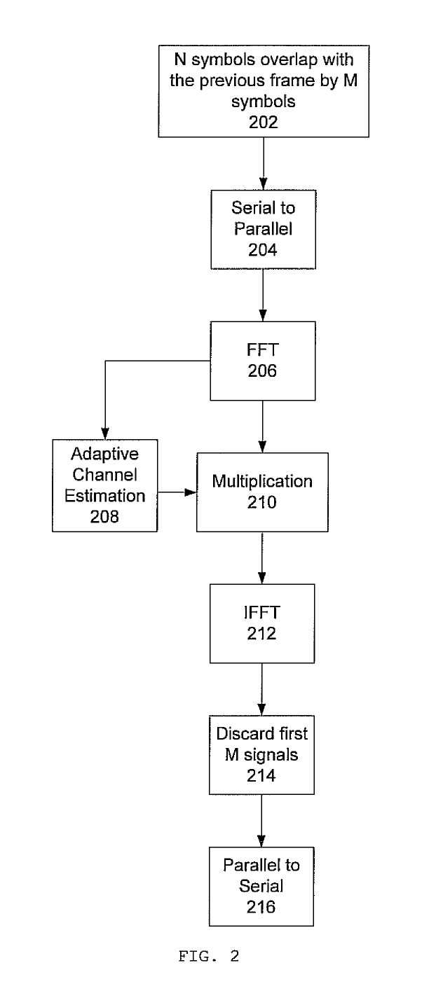

The process performed by the adaptive FDE is illustrated as a block/flow diagram in FIG. 2. When a signal is received, CD and PMD cause overlap of the time-based signals. Each frame comprises N symbols, and has an overlap of M symbols with the previous frame due to channel delay spread. This input is represented by block 202.

The adaptive FDE converts each frame from a serial signal to a parallel signal at block 204. The adaptive FDE then converts the time-time signal to a frequency-domain signal using a fast Fourier transform (FFT) at block 206. The parallel, time-domain signal is also used for dual-dispersion estimation at block 208, producing coefficients.

The coefficients determined in dual-dispersion estimation 208 are used to compensate for both CD and PMD simultaneously. These coefficients can be obtained by either training-based approach or blind approach. In the training-based approach, a training sequence is inserted into the transmitted signal periodically at the transmitter. By measuring the received signal, the receiver can estimate the channel response and thereby calculate the coefficients for the equalization. For example, after the FFT operation, the received signal can in frequency domain be expressed as F(n)=X(n)H(n)+N(n), where n represents nth frequency tone, X(n) is the training signal, N(n) is noise, and H(n) is the information channel. By neglecting the noise component, an expression for the information channel is shown to be

$$H ( n ) = \frac{F ( n )}{X ( n )} .$$

H(n) is then used in the equalization for the incoming data symbols following the training sequence. It should be noted that, since the channel is time-varying, the receiver needs to update H(n) every Nₕ data symbols to track the dynamics of the channel, where Nₕ is a pre-determined parameter.

After obtaining H(n), the equalized signal y(n) may be calculated. As noted above, each frame of data comprises N symbols. Let z(n)ε{z(1), z(2), . . . , z(N)} represent the nth symbol in the frequency domain. Two options for training-based equalization are zero-forcing equalization and minimum squared error equalization.

For zero-forcing equalization, the equalized signal y(n) may be expressed as

$$y ( n ) = \frac{z ( n )}{H ( n )} ,$$

where nε{1, . . . , N}. For minimum squared error equalization, y(n) may be expressed as

$$y ( n ) = z ( n ) \frac{{H}^{H} ( n )}{H ( n ) {H}^{H} ( n ) + {σ}^{2}} ,$$

where H^{H}(n) is the conjugate transpose of H(n) and σ² is the channel noise variance (a pre-determined parameter).

In the blind approach, no training sequence is used. The receiver estimates the channel response by calculating the statistics of the received signal. The estimation of coefficients allows the adaptive FDE 112 to flexibly respond to changes in the distortion of the incoming signal.

Channel estimation is frequently more complex computationally, but may be performed using a constant modulus algorithm or a linear-programming based algorithm. These algorithms may be used when the use of a training signal is impractical or undesirable.

The frequency-domain signal is then multiplied by the estimated coefficients at block 210, compensating for channel delay spread in the frequency domain. This simple arithmetical operation in the frequency domain accomplishes the task of a time-domain finite impulse response (FIR) filter, but with far less complexity. By operating in the frequency domain, the number of multiplication operations and channels can be reduced by more than a factor of twenty. The signal is then converted back into the time-domain using an inverse FFT at block 212. The first M signals are discarded at block 214, and the remaining N-M signals are then converted to a serial signal at block 216.

This technique leads to greatly reduced complexity in compensating for CD and PMD. CD and PMD cause the convolution of signals, resulting in signals which are very difficult to equalize in the time domain. However, because the convolution of two time-domain signals is a simple multiplication in the frequency domain, conversion from the time domain to the frequency domain makes the problem significantly more tractable. The FFT provides for rapid conversion between the time domain and the frequency domain, such that the small overhead in converting to and from the frequency domain is more than made up for by the efficiencies gained in performing by a simple arithmetic operation in the frequency domain without the use of a cyclic prefix.

The present principles allow for implementations with substantially reduced cost and complexity, and also avoid the significantly decreases possible throughput that results from the insertion of cyclic prefixes. As a result of this simplicity, the present principles may be implemented on a digital signal processing chip.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A polarization-multiplexing, optical receiver, comprising:
an adaptive frequency domain equalizer, comprising:
a fast Fourier transform (FFT) module for converting a time-domain input signal to a frequency-domain signal;
a dual-dispersion estimation module for calculating coefficients from the time-domain input signal, the coefficients representing a correction for both chromatic dispersion and polarization-mode dispersion;
a multiplier that multiplies the coefficients and the frequency-domain signal to produce a compensated frequency-domain signal without chromatic dispersion or polarization mode dispersion; and
an inverse FFT module for converting the frequency-domain signal to a time-domain output signal.

2. The equalizer of claim 1, further comprising a local oscillator which produces a reference signal.

3. The equalizer of claim 2, further comprising a 90° optical hybrid, which receives a polarization-multiplexed, optical signal and the reference signal and produces a plurality of optical outputs.

4. The equalizer of claim 3, further comprising a plurality of photodetectors, each of which receives an optical output and produces an electrical signal.

5. The equalizer of claim 4, further comprising a frequency offset compensator for receiving the plurality of electrical signals and reducing them to complex polarization signals.

6. The equalizer of claim 5, further comprising a data demodulator for receiving the time-domain output signal and producing output data.

7. The equalizer of claim 1, wherein the dual-dispersion estimation module calculates coefficients using a training sequence.

8. The equalizer of claim 7, wherein the dual-dispersion estimation module uses zero-forcing equalization to calculate coefficients.

9. The equalizer of claim 7, wherein the dual-dispersion estimation module uses minimum squared error equalization to calculate coefficients.

10. The equalizer of claim 1, wherein the dual dispersion estimation module calculates coefficients using statistics of the received signal.

11. A method for receiving optical signals, comprising:
compensating for chromatic dispersion and polarization-mode dispersion in a complex polarization signal in the frequency domain, comprising:
determining coefficients from the complex polarization signal, the coefficients representing a correction for both chromatic dispersion and polarization-mode dispersion;
converting the complex polarization signal to a frequency-domain signal;
multiplying the coefficients and the frequency-domain signal to produce a compensated frequency-domain signal without chromatic dispersion or polarization mode dispersion; and
converting the compensated frequency-domain signal to a time-domain output signal.

12. The method of claim 11, further comprising:
receiving a polarization-multiplexed, optical input signal;
generating a reference signal in a local oscillator; and
combining the input signal and the reference signal in a 90° optical hybrid to produce a plurality of optical outputs.

13. The method of claim 12, further comprising converting the optical outputs to electrical signals using a plurality of photodetectors.

14. The method of claim 13, further comprising receiving the plurality of electrical signals at a frequency offset compensator and reducing the electrical signals to complex polarization signals.

15. The method of claim 14, further comprising a data demodulator for receiving the time-domain output signal and producing output data.

16. The method of claim 11, wherein the coefficients are determined using a training sequence.

17. The method of claim 16, wherein coefficients are determined using zero-forcing equalization.

18. The method of claim 16, wherein coefficients are determined using minimum squared error equalization.

19. The method of claim 11, wherein the coefficients are determined using statistics of the received signal.

20. A computer readable medium comprising a computer readable program, wherein the computer readable program when executed on a computer causes the computer to perform the method of claim 11.
